(19) United States
(12) Patent Application Publication
(10) Pub. No.: US 2024/0034372 A1
(43) Pub. Date: Feb. 1, 2024

(54) OPTICAL RAILWAY DETECTION

(71) Applicant: Siemens Mobility GmbH, München (DE)

(72) Inventors: Benjamin Hartmann, Berlin (DE); Benoit Bleuze, Berlin (DE); Albi Sema, Berlin (DE); Irina Vidal Migallon, Berlin (DE); San-Yu Huang, Berlin (DE); Christoph Reinbothe, Hoppegarten (DE)

(21) Appl. No.: 18/256,957

(22) PCT Filed: Aug. 26, 2021
(86) PCT No.: PCT/EP2021/073593

§ 371 Date: Jun. 12, 2023

(30) Foreign Application Priority Data
Dec. 11, 2020 (DE) 10 2020 215 754.5

(51) Int. Cl. B61L 23/04; B61L 15/00; G06V 10/774; G06V 10/10; G06V 10/82; G06V 20/58; G06V 10/26; G06T 7/50

(52) U.S. Cl. CPC B61L 23/041; B61L 15/0072; G06V 10/774; G06V 10/16; G06V 10/82; G06V 20/58; G06V 10/26; G06T 7/50; G06T 2207/30261; G06T 2207/20081; G06T 2207/20084

(57) ABSTRACT

A method creates a training data set for optical railway detection with integrated obstacle detection. The method includes the following steps of: providing first images of railways for rail vehicles, each first image having a representation of a railway; providing second images of objects, each second image containing a representation of at least one object; combining the first and second images; and generating third images containing the combined first and second images. Each third image contains a representation of a railway with at least one object, and a number of the third images forming the training data set for the optical railway detection with integrated obstacle detection.

The invention relates to a method for creating a training data set for optical railroad line detection with integrated obstacle detection. The invention also relates to a method for training optical railroad line detection with integrated obstacle detection. Furthermore, the invention relates to a method for railroad line detection with integrated obstacle detection by means of a rail vehicle and a computing unit for performing the method for railroad line detection with integrated obstacle detection.

Optical railroad line detection with integrated obstacle detection can take place by means of artificial neural networks, wherein this requires a large number of digital images of different rail routes with obstacles located on the rail routes in order to successfully train the neural network. However, the occurrence of obstacles on railroad lines is a comparatively rare event and consequently only a low number of usable image recordings of such events are available. Hence, at present there are no data sets of image recordings of railroad lines with objects arranged on the railroad lines that would enable training of neural networks for optical railroad line detection with integrated obstacle detection.

The invention is based on the object of providing a method for creating a training data set for optical railroad line detection with integrated obstacle detection that circumvents these limitations. A further object of the invention is to provide a training method for optical railroad line detection with integrated obstacle detection, a method for optical railroad line detection with integrated obstacle detection and a computing unit for performing the method for optical railroad line detection with integrated obstacle detection each of which is based on the training data set.

This object is achieved by a method for creating a training data set for optical railroad line detection, as well as a method for training optical railroad line detection, a method for determining the position of a rail vehicle and a computing unit for performing the method for determining the position. Advantageous embodiments are disclosed in the subclaims.

According to one aspect of the invention, a method for creating a training data set for optical railroad line detection with integrated obstacle detection is provided, wherein the method comprises the following steps:
providing first image recordings of railroad lines for rail vehicles, wherein each first image recording comprises a representation of a railroad line;
providing second image recordings of objects, wherein each second image recording comprises a representation of at least one object;
combining the first and second image recordings; and
generating third image recordings from the combined first and second image recordings, wherein each third image recording comprises a representation of a railroad line with at least one object, and wherein a plurality of the third image recordings form the training data set for the optical railroad line detection with integrated obstacle detection.

This can achieve the technical advantage that it is possible to provide an improved method for creating a training data set for optical railroad line detection with integrated obstacle detection, wherein the training data set is based on image recordings each comprising at least one railroad line and at least one object. For this purpose, first image recordings of railroad lines and second image recordings of objects are provided and combined with one another. Subsequently, third image recordings are generated from the combined first and second image recordings of the railroad lines and the objects, wherein each third image recording comprises at least one railroad line and at least one object. Thus, a plurality of the third image recordings form the training set for the optical railroad line detection with integrated obstacle detection.

Hence, the method according to the invention enables cost-effective generation of a training data set with railroad lines and objects that does not require the time-consuming and expensive creation of image recordings of real situations in which objects are arranged on railroad lines.

For the purposes of the application, a railroad line is a rail track for rail vehicles and comprises at least two parallel rails.

According to one embodiment, the first image recording data comprises image recordings of real railroad lines from an RGB camera.

This can achieve the technical advantage that it enables the provision of an improved training data set for optical railroad line detection with integrated obstacle detection based on image recordings of real railroad lines from RGB cameras. Optical railroad line detection with integrated obstacle detection trained on such a training data set can hence preferably be operated in a rail vehicle equipped with RGB cameras for object detection. This can achieve the provision of extremely simple and precise optical railroad line detection with integrated obstacle detection. Optical railroad line detection with integrated obstacle detection trained in this way can be operated exclusively with RGB image recordings and does not require any further environmental sensor data for railroad line and obstacle detection.

According to one embodiment, the first image recording data comprises image recordings of real railroad lines from a LiDAR sensor and/or a stereo camera.

This can achieve the technical advantage that the use of LiDAR sensors and/or stereo cameras based on the first image recordings enables a distance to be determined by the correspondingly trained optical railroad line detection with integrated obstacle detection. Hence, railroad line detection with integrated obstacle detection trained in this way can be operated with image recordings from RGB cameras, LiDAR sensors and/or stereo cameras.

According to one embodiment, the second image recording data comprises image recordings of real objects and/or virtually generated image recordings of real and/or virtual objects from an RGB camera and/or from a LiDAR sensor and/or a stereo camera.

This can achieve the technical advantage that it enables the provision of a wide range of applications of the method for creating a training data set for optical railroad line detection with integrated obstacle detection. Herein, the second image recordings can be image recordings from RGB cameras, LiDAR sensors or stereo cameras. Hence, optical railroad line detection with integrated obstacle detection trained in this way can be used based on RGB image recording data, LiDAR image recording data or stereo camera image recording data. In addition or alternatively, the objects can be generated virtually. In this way, it can be achieved that the objects can be adapted according to the later training method. In addition, the generation of objects for which no image recordings of real objects exist is also possible.

According to one embodiment, the combining of the first and second image recording data comprises:
randomized arrangement of an object in the second image recordings in the first image recording of the railroad line, wherein the randomized arrangement comprises randomized positioning of the object relative to the railroad line in the first image recording and/or randomized orientation of the object relative to the railroad line in the first image recording and/or randomized sizing of the object relative to the railroad line in the first image recording.

This can achieve the technical advantage that it enables improved training of the optical railroad line detection with integrated obstacle detection and in particular improved object detection or obstacle detection to be achieved. The randomized arrangement of the objects in the second image recordings in the first image recordings enables the achievement of improved training performance of the optical railroad line detection with integrated obstacle detection to be trained.

According to a second aspect of the invention, a method for training optical railroad line detection with integrated obstacle detection is provided, wherein the method comprises:
reading in, by means of at least one neural network, third image recordings with railroad lines and objects that were generated with the method in the preceding embodiments;
detecting, by means of the at least one neural network, railroad lines and/or obstacles in the third image recordings, wherein the neural network exclusively detects objects positioned on the railroad lines as obstacles, and wherein, herein, detection parameters are learned by means of the at least one neural network.

This can provide the technical advantage of improved training of rail detection with integrated obstacle detection comprising the technical advantages of the method according to the invention for creating a training data set for optical railroad line detection with integrated obstacle detection.

According to one embodiment, the detection of the railroad lines and the obstacles comprises segmentation of railroad lines and objects arranged on the railroad lines in the third image recordings, wherein the segmentation of railroad lines comprises contrasting between railroad lines and image recording background, and wherein the segmentation of the objects comprises contrasting between objects arranged on the railroad lines and image recording background.

This can achieve the technical advantage that it enables the provision of railroad line detection with integrated obstacle detection that is as precise as possible. Segmentation enables each pixel of the third image recordings to be assigned to the image recording background, a railroad line or an object. This enables precise railroad line detection or object detection to be achieved.

According to one embodiment, the segmentation comprises semantic segmentation and/or semantic instance segmentation of the railroad lines and objects.

This can achieve the technical advantage that it enables precise detection of railroad lines and objects. Semantic segmentation or semantic instance segmentation enables differentiation between railroad lines and objects arranged on the railroad lines to be achieved.

In addition, semantic instance segmentation enables differentiation between different objects to be achieved.

According to one embodiment, the neural network is embodied as a convolutional neural network, in particular as an encoder-decoder convolutional neural network, wherein the neural network is trained to detect railroad lines and obstacles.

This can achieve the technical advantage that it enables the provision of precise and reliable optical railroad line detection with integrated obstacle detection. The neural network embodied as a convolutional neural network, in particular as an encoder-decoder convolutional neural network, enables the provision of the simultaneous detection of railroad lines and obstacles. The fact that exclusively one neural network is used enables the provision of the simplest possible optical railroad line detection with integrated obstacle detection.

According to one embodiment, the optical railroad line detection with integrated obstacle detection comprises two neural networks, wherein the two neural networks are each embodied as a convolutional neural network, and wherein one neural network is trained to detect railroad lines, and wherein the respective other neural network is trained to detect obstacles.

This can achieve the technical advantage that it enables a simplified training process for the optical railroad line detection with integrated obstacle detection. The provision of two neural networks of which one is trained for railroad line detection and one is trained for obstacle detection can simplify the training process.

According to one embodiment, the optical railroad line detection with integrated obstacle detection comprises a distance module, wherein the method further comprises:
determining, by means of the distance module, the distance between objects and a reference point in the third image recordings, wherein, herein, the distance module learns distance-determining parameters.

This can achieve the technical advantage that it enables the provision of improved optical railroad line detection with integrated obstacle detection by means of which it is possible to determine the distance of objects from a reference point. The reference point can be defined by the positioning of the rail vehicle on the railroad line.

According to a third aspect of the invention, a method for railroad line detection with integrated obstacle detection by means of a rail vehicle with the following steps is provided:
reading in an image recording from a camera, wherein the camera is arranged in a front area of the rail vehicle;
performing optical railroad line detection with integrated obstacle detection that has been trained according to the method according to one of the preceding embodiments;
detecting a railroad line on which the rail vehicle is moving and an object arranged on the railroad line as an obstacle by means of the optical rail detection using the detection parameters.

This can enable the provision of the technical advantage of improved rail detection with integrated obstacle detection comprising the technical advantages of the method according to the invention for creating a training data set for optical railroad line detection with integrated obstacle detection and the technical advantages of the method according to the invention for training optical railroad line detection with integrated obstacle detection.

According to a fourth aspect, a computing unit is provided which comprises at least one artificial neural network and is configured to be trained according to the method for training according to the preceding embodiments and, after the training has been performed, to execute the method in the preceding embodiment.

The above-described properties, features and advantages of this invention and the manner in which these are achieved will become clearer and more plainly comprehensible from the explanations of the following greatly simplified schematic exemplary embodiments. Herein, in schematic representations in each case:

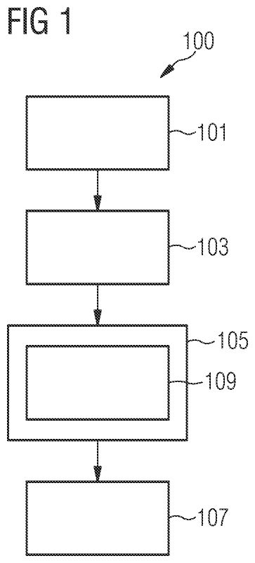

FIG. 1 shows a flowchart of a method for creating a training data set for optical railroad line detection with integrated obstacle detection according to one embodiment;

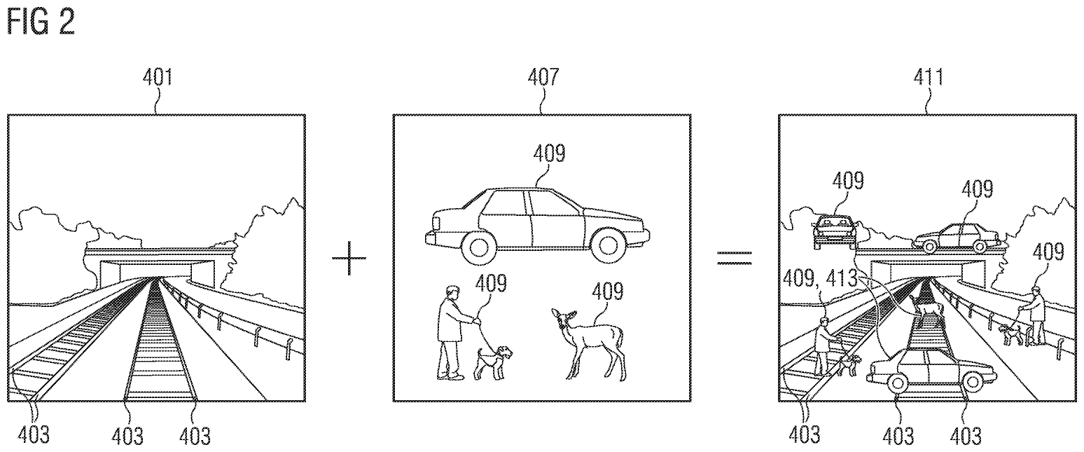

FIG. 2 shows a graphical representation of the method for creating a training data set for optical railroad line detection with integrated obstacle detection according to one embodiment;

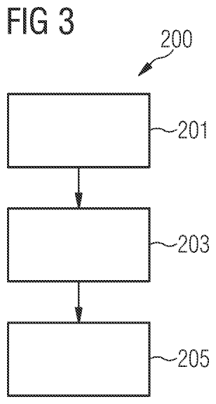

FIG. 3 shows a flowchart of a method for training optical railroad line detection with integrated obstacle detection according to one embodiment;

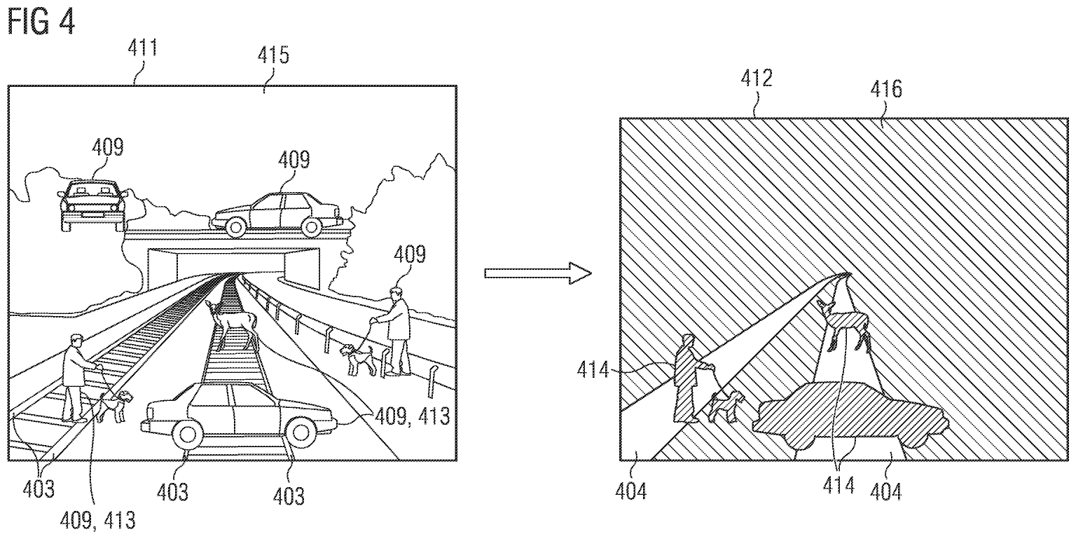

FIG. 4 shows a graphical representation of the method for training optical railroad line detection with integrated obstacle detection according to one embodiment;

FIG. 5 shows a flowchart of a method for optical railroad line detection with integrated obstacle detection according to one embodiment; and

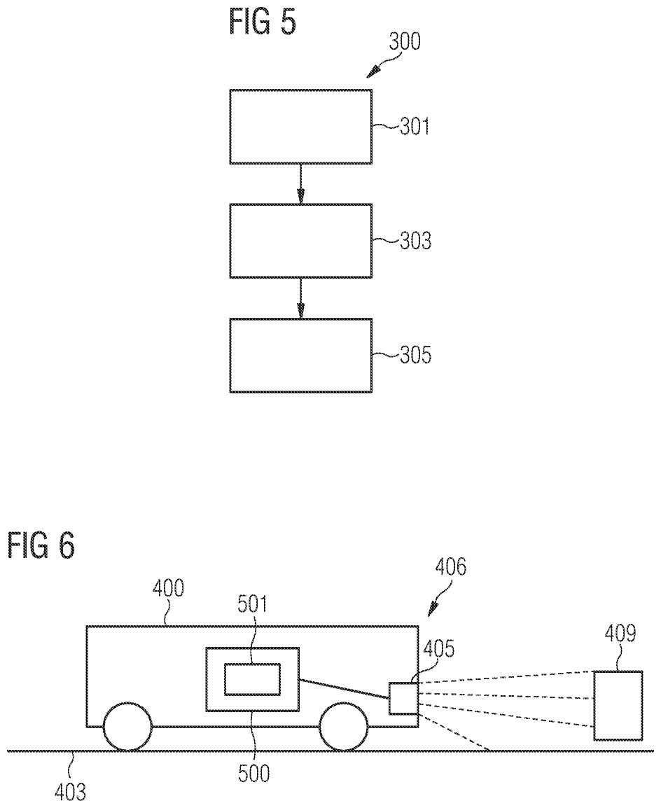

FIG. 6 shows a rail vehicle with a computing unit.

FIG. 1 shows a flowchart of a method 100 for creating a training data set for optical railroad line detection with integrated obstacle detection according to one embodiment.

The description of the method 100 for creating a training data set for optical railroad line detection with integrated obstacle detection according to the embodiment in FIG. 1 is made with reference to FIG. 2.

Thus, in a first method step 101, first image recordings 401 of railroad lines 403 are provided. The first image recordings 401 can, for example, be real images from an RGB camera showing real railroad lines 403. FIG. 2 shows such a real image of a railroad line 403. Alternatively, the first image recordings 401 of railroad lines 403 can comprise image recordings from LiDAR sensors or stereo cameras. In order to provide the first image recordings 401, corresponding recordings of real railroad lines 403 can be created. Alternatively, pre-existing data sets of railroad lines 403 can be used for this purpose.

In a subsequent method step 103, second image recordings 407 of objects 409 are provided. The second image recordings 407 can comprise RGB image recordings of real objects 409, LiDAR sensor image recordings of real objects 409 or stereo camera image recordings of real objects 409. The recordings can be explicitly generated to create the training data set. Alternatively, it is possible to use pre-existing data sets of recordings of railroad lines. Alternatively or additionally, the second image recordings 407 can comprise virtually generated recordings of artificially generated virtual objects 409.

The objects 409 can represent any items or people or animals. Alternatively, objects 409 can only represent geometric shapes or three-dimensional geometric bodies.

In a further method step 105, the first and second image recordings 401, 407 are combined.

In the embodiment shown, the combining of the first and second image recordings 401, 407 comprises a method step 109 in which the objects 409 in the second image recordings 407 are arranged in a randomized manner in the first image recordings 401. Herein, the randomized arrangement of the objects 409 can comprise randomized positioning of the objects 409 in the first image recordings 401 in that the objects 409 in the second image recordings 407 are arranged at arbitrary positions within the first image recordings 401. In addition, the randomized arrangement can comprise randomized orientation of the objects 409 with which the objects 409 are arranged in an arbitrary alignment relative to the railroad lines 403 in the first image recordings 401. In addition, the randomized arrangement can comprise the integration of the objects 409 into the first image recordings 401 with arbitrary sizing.

Subsequently, in a method step 107, third image recordings 411 are generated based on the combined first and second image recordings 401, 407, wherein each third image recording 411 comprises at least one railroad line 403 and at least one object 409.

Herein, the third image recordings 411 can comprise a plurality of railroad lines 403 and a plurality of objects 409. The objects 409 can be arranged with arbitrary sizing, positioning and orientation relative to the railroad lines 403 in the third image recordings 411.

FIG. 2 shows a graphical representation of the method 100 for creating a training data set for optical railroad line detection with integrated obstacle detection according to one embodiment.

FIG. 2 shows a graphical representation of the creation of the training data set according to the method 100 in the embodiment in FIG. 1.

First, first image recordings 401 of railroad lines 403 are provided. These can be real recordings of real railroad lines 403, for example from RGB cameras.

Furthermore, second image recordings 407 of objects 409 are provided; these can comprise both real objects 409 and synthetically generated virtual objects.

The first and second image recordings 401, 407 are subsequently combined and third image recordings 411 based on the first and second image recordings 401, 407 are generated accordingly. To generate the third image recordings 411, the objects 409 in the second image recordings 407 are arranged in the first image recordings in a randomized manner. As depicted in FIG. 2, for this purpose, the different objects 409 are arranged with arbitrary positioning, orientation and sizing relative to the railroad lines 403 in the third image recordings 411. Herein, realistic arrangement of the objects 409 with realistic positioning, orientation or sizing in relation to the real railroad lines 403 is not absolutely necessary.

Finally, a plurality of third image recordings 411 generated in this way form the training data set for the railroad line detection with integrated object detection to be trained.

FIG. 3 shows a flowchart of a method 200 for training optical railroad line detection with integrated obstacle detection according to one embodiment.

The method 200 for training optical railroad line detection with integrated obstacle detection in the embodiment in FIG. 3 is described with reference to the description for FIG. 4.

In a first method step 201, third image recordings 411 with railroad lines 403 and objects 409 are read in by means of at least one neural network 501. Herein, the third image recordings 411 were generated with the method 100 for creating a training data set for optical railroad line detection with integrated obstacle detection according to the method steps described above.

Following this, in a subsequent method step 203, the at least one neural network detects railroad lines 403 and/or obstacles 413 in the third image recordings 411. Herein, the neural network 501 exclusively detects objects 409 positioned in the third image recordings 411 on the railroad lines 403 as obstacles 413. In contrast, objects that do not cover or cross a corresponding railroad line 403 in the third image recordings 411 are not detected as obstacles by the neural network 501.

Herein, the neural network 501 can be trained to detect objects 409 within the third image recordings 411 and to differentiate between objects 409 arranged on corresponding railroad lines 403 and objects 409 that are not located on railroad lines 403.

According to one embodiment, the neural network 501 can be embodied as a convolutional neural network and in particular as an encoder-decoder convolutional neural network. The neural network 501 can in particular be embodied to detect railroad lines 403 and objects 409 or obstacles 413.

Alternatively, the optical railroad line detection with integrated obstacle detection can comprise two neural networks 501 which are, for example, each embodied as convolutional neural networks. Herein, a neural network 501 can be configured to detect railroad lines 403 while the respective other neural network can be configured to detect objects 409 or obstacles 413.

According to one embodiment, the optical railroad line detection with integrated obstacle detection can furthermore comprise a distance module that is configured to determine a distance of the objects 409 in the third image recordings 411 from a predetermined reference point. Here, the predetermined reference point can, for example, be defined by the positioning of the camera by means of which the first image recordings 401 were taken relative to the railroad lines 403 or objects 409.

In a further method step 205, distances of the objects 409 in the third image recordings 411 from the reference point P, for example the RGB camera, are correspondingly detected by the distance module.

The detection of the railroad lines 403 or obstacles 413 in method step 203 enables detection parameters to be learned by the neural network 501 and thus a training process for the neural network 501 to be performed. Similarly, the determination of the distances of the objects 409 enables the distance module to learn corresponding distance-determining parameters in method step 205, as a result of which the distance module is trained accordingly.

The described training process can, for example, be performed according to supervised learning or unsupervised learning. In particular, the neural network 501 or the plurality of neural networks 501 can be trained according to a backpropagation process common in the prior art.

According to one embodiment, the detection of the railroad lines 403 and/or the obstacles 413 or the objects 409 in method step 203 can comprise segmentation of railroad lines 403 and objects 409 or obstacles 413 in the third image recordings 411. Herein, the segmentation can, for example, be semantic segmentation or semantic instance segmentation. For this segmentation, it is determined for each pixel of the third image recording 411 whether the respective pixel belongs to a railroad line 403, an obstacle 413 or the image recording background of the third image recording 411. Hence, segmentation performed in this way enables contrasting between railroad lines 403, obstacles 413 and the image recording background of the third image recording 411 to be achieved. Herein, the segmentation of the third image recordings 411 can be performed according to segmentation processes known from the prior art.

FIG. 4 shows a graphical representation of the method 200 for training optical railroad line detection with integrated obstacle detection according to one embodiment.

FIG. 4 is a graphical representation illustrating the training process according to the method 200 in the embodiment depicted in FIG. 3.

To train the neural network 501 or neural networks 501, third image recordings 411 with railroad lines 403 and objects 409 are read in by the neural networks 501.

During the training process, detection parameters are learned by the neural networks 501 for the detection of the railroad lines 403 and the objects 409 arranged on the railroad lines 403 by the neural networks 501. During the training process, the neural networks 501 perform segmentation of the railroad lines 403, obstacles 413 or the image recording background of the third image recordings 411.

Furthermore, FIG. 4 depicts a segmented image recording 412 in which two segmented railroad lines 404 and in each case three segmented obstacles 414 and a segmented image recording background 416 of the third image recording 411 shown in FIG. 4 are depicted. The segmentation depicted here enables differentiation between the segmented railroad line and segmented obstacles 414 thus enabling an unambiguous distinction to be made between the railroad line and objects 409 arranged on the railroad line 403, hereby enabling the unambiguous detection of obstacles 413 defined by objects 409 arranged on the railroad lines 403 by the correspondingly trained neural networks 501.

As depicted in FIG. 4, the objects 409 in the third image recording 411 that are not arranged on the railroad line 403 are not detected as obstacles 413.

Herein, the detection of an arrangement of objects 409 arranged on railroad lines 403 can, for example, be ascertained from the overlapping of the outline of an object 409 with the outline of a railroad line 403. Alternatively, it is possible to take account of perspective criteria by means of which, for example, a vertical distance between the object 409 and the railroad line 403 can be ascertained. This can enable objects 409, such as, for example, vegetation covering the railroad line 403 or birds flying over the railroad line 403, which are only arranged on the railroad line 403 on the basis of the perspective representation in the image recording, to be identified as non-threatening objects and hence to be excluded as obstacles 413. This enables a more precise classification of obstacles 413 and the avoidance of false-positive detection results in which objects 409 are classified as obstacles 413 although they are not arranged on the railroad line 403 and hence do not actually represent any obstruction to the rail vehicle.

FIG. 5 shows a flowchart of a method 300 for optical railroad line detection with integrated obstacle detection according to one embodiment.

The embodiment of the method 300 for railroad line detection with integrated obstacle detection by means of a rail vehicle 400 is described with reference to FIG. 6.

In order to detect railroad lines 403 or obstacles 413 by means of a rail vehicle 400, first, in a method step 301, image recordings of the rail vehicle 400 from a camera 405 are read in by the optical railroad line detection with integrated obstacle detection and in particular the neural network 501 of the optical railroad line detection with integrated obstacle detection. Herein, the camera 405 can, for example, be an RGB camera arranged in a front area 406 of the rail vehicle 400 and which is able to view a region in front of the rail vehicle 400 in the direction of travel in which at least the railroad line 403 on which the rail vehicle 400 is moving can be viewed.

Herein, the optical railroad line detection with integrated obstacle detection and in particular the corresponding neural network 501 were trained according to the method 200, wherein, for this purpose, a corresponding training data set generated in accordance with the method 100 was used.

In a subsequent method step 303, optical railroad line detection with integrated obstacle detection is performed in a subsequent method step 303.

Based on this, in a method step 305, the railroad line 403 on which the rail vehicle 400 is moving is detected and, if applicable, an object 409 arranged on the railroad line 403 is identified as an obstacle 413. Herein, the detection of the railroad line 403 or the obstacle 413 by the optical railroad line detection with integrated obstacle detection and in particular by the correspondingly trained neural network 501 can be performed according to the explanations for method 200 by way of corresponding segmentation of the image recordings.

If a corresponding obstacle 413 is detected, a corresponding warning signal can be issued or a braking process of the rail vehicle 400 can be initiated.

FIG. 6 shows a rail vehicle with a computing unit.

FIG. 6 shows a rail vehicle 400 arranged on a railroad line 403. The rail vehicle 400 comprises a computing unit 500 on which a neural network 501 is configured which is trained according to the method 200 to perform railroad line detection and obstacle detection. The computing unit 500 can be embodied as a software module or as a hardware component with a corresponding software module. The rail vehicle 400 comprises in a front area 406 a camera 405 that can view a region in which at least the railroad line 403 on which the rail vehicle 400 is moving can be viewed. The camera 405 can, for example, be an RGB camera and is connected to the computing unit 500 for data communication purposes.

The image recordings from the camera 405 enable the neural network 501 to perform railroad line detection or obstacle detection according to the method 300.

FIG. 6 furthermore shows an object 409 which is arranged adjacent to the front area 406 of the rail vehicle 400 on the railroad line 403 and can be viewed by the camera 405.

According to one embodiment, the rail vehicle 400 can furthermore comprise a LiDAR sensor or an additional stereo camera which can likewise be arranged in the front area 406 and are not depicted in FIG. 6. Based on the data from the LiDAR sensor or the stereo camera, the optical railroad line detection with integrated obstacle detection can determine the distance of the object 409 from the rail vehicle 400.

Alternatively, furthermore, a distance module (not depicted in FIG. 6) of the optical railroad line detection with integrated obstacle detection can be configured on the computing unit 500, said distance module being embodied, based on the image recordings from the camera 405, to determine the distance of the object 409 relative to the rail vehicle 400.

Although the invention has been illustrated and described in greater detail by the preferred exemplary embodiment, the invention is not restricted by the disclosed examples and other variations can be derived herefrom by the person skilled in the art without departing from the scope of protection of the invention.

1-13. (canceled)

14. A method for creating a training data set for optical railroad line detection with integrated obstacle detection, the method comprises the following steps of:
providing first image recordings of railroad lines for rail vehicles, wherein each of the first image recordings contains a representation of a railroad line;
providing second image recordings of objects, wherein each of the second image recordings contains a representation of at least one object;
combining the first and second image recordings; and
generating third image recordings from combined first and second image recordings, wherein each of the third image recordings contains a representation of the railroad line with the object, and wherein a plurality of the third image recordings form the training data set for the optical railroad line detection with integrated obstacle detection.

15. The method according to claim 14, wherein the first image recordings contain image recordings of real railroad lines from an RGB camera.

16. The method according to claim 15, wherein the first image recordings contain further image recordings of the real railroad lines from a LiDAR sensor and/or a stereo camera.

17. The method according to claim 14, wherein the second image recordings contain image recordings of real objects from an RGB camera and/or a LiDAR sensor and/or a stereo camera and/or virtually generated image recordings of real and/or virtual objects.

18. The method according to claim 14, wherein the step of combining the first and second image recordings, comprises the further sub-steps of:
disposing the object of the second image recordings in a randomized manner in a first image recording of the railroad line resulting in a randomized arrangement, wherein the randomized arrangement includes randomized positioning of the object relative to the railroad line in the first image recording and/or a randomized orientation of the object relative to the railroad line in the first image recording and/or a randomized sizing of the object relative to the railroad line in the first image recording.

19. A method for training optical railroad line detection with integrated obstacle detection, the method comprises:
reading in, by means of at least one neural network, third image recordings with railroad lines and objects that were generated with a method according to claim 14; and
detecting, by means of the at least one neural network, the railroad lines and/or obstacles in the third image recordings, wherein the at least one neural network exclusively detects the objects positioned on the railroad lines as the obstacles, and wherein, herein, detection parameters are learned by means of the at least one neural network.

20. The method according to claim 19, wherein the step of detecting the railroad lines and the obstacles includes segmenting the railroad lines and the objects disposed on the railroad lines in the third image recordings, wherein a segmentation of the railroad lines includes contrasting between the railroad lines and image recording background, and wherein a segmentation of the objects includes contrasting between the objects disposed on the railroad lines and the image recording background.

21. The method according to claim 20, wherein the segmentation includes semantic segmentation and/or semantic instance segmentation of the railroad lines and the objects.

22. The method according to claim 19, wherein:
the at least one neural network is embodied as a convolutional neural network; and
the at least one neural network is trained to detect the railroad lines and the obstacles.

23. The method according to claim 19, wherein the optical railroad line detection with integrated obstacle detection is performed by two neural networks, wherein the two neural networks are each embodied as a convolutional neural network, and wherein one of the two neural networks is trained to detect the railroad lines, and wherein a respective other of the two neural networks is trained to detect the obstacles.

24. The method according to claim 19, wherein the optical railroad line detection with integrated obstacle detection uses a distance module, and wherein the method further comprises:
determining, by means of the distance module, a distance of the objects from a reference point in the third image recordings, wherein, herein, the distance module learns distance-determining parameters.

25. The method according to claim 22, wherein the at least one neural network is embodied as an encoder-decoder convolutional neural network.

26. A method for railroad line detection with integrated obstacle detection by means of a rail vehicle, the method comprises the following steps of:
reading in an image recording from a camera, wherein the camera is disposed in a front area of the rail vehicle;
performing optical railroad line detection with integrated obstacle detection that has been trained according to a method according to claim 19; and
detecting the railroad line on which the rail vehicle is moving and the object disposed on the railroad line as an obstacle by means of the optical rail line detection using detection parameters.

27. A computing unit, comprising:
an artificial neural network;
the computing unit being configured to perform a method for creating a training data set for optical railroad line detection with integrated obstacle detection, the method comprises the following steps of:
providing first image recordings of railroad lines for rail vehicles, wherein each of the first image recordings containing a representation of a railroad line;
providing second image recordings of objects, wherein each of the second image recordings containing a representation of at least one object;
combining the first and second image recordings; and
generating third image recordings from combined first and second image recordings, wherein each of the third image recordings containing a representation of the railroad line with the at least one object, and wherein a plurality of the third image recordings form the training data set for the optical railroad line detection with integrated obstacle detection;
after the training has been performed, the computing unit being configured to perform a method for the optical railroad line detection with integrated obstacle detection by means of a rail vehicle, the method comprises the following steps of:
reading in an image recording from a camera, wherein the camera is disposed in a front area of the rail vehicle;
performing optical railroad line detection with integrated obstacle detection that has been trained; and
detecting the railroad line on which the rail vehicle is moving and the at least one object disposed on the railroad line as an obstacle by means of the optical rail line detection using detection parameters.
